(19) United States
(12) Patent Application Publication
(10) Pub. No.: US 2006/0168344 A1
(43) Pub. Date: Jul. 27, 2006

(54) Address book information sharing system and method thereof

(75) Inventor: Hiroteru Tsuchiya, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/000,086

(22) Filed: Dec. 1, 2004

(51) Int. Cl. G06F 15/16

(52) U.S. Cl. 709/245

(57) ABSTRACT

An address book information sharing system includes an LDAP server having a sharing address book and a LDAP server function and a plurality of communication terminals having an LDAP client function and respective address books which share the address book information between the communication terminals via the LDAP server. Each communication terminal executes an address book conversion process so as to apply address information of its address book to the LDAP and writes and registers the results of the conversion process into the sharing address book of the LDAP server. Each communication terminal further obtains the address information of the sharing address book by inquiering the LDAP server and converts the address information so as to apply the address information obtained to the address book thereof. The results are stored.

### BACKGROUND OF THE INVENTION

1. Field of the Invention

The present invention relates to an address book information sharing system by which information of an address book can be shared between communication terminals, to a communication terminal used in this system, and to a method for sharing the address book information.

2. Description of the Related Art

As a method for customizing a communication terminal such as a facsimile terminal, a telephone set, or the so-called multi-function peripheral (hereinafter, abbreviated to MFP) and for easily and correctly communicating a message to a predetermined destination by a user, an address book function is available. The address book function realizes a mechanism of registering address information having a high use frequency, that is, a destination address and related information in an address book memory, and communicating a message to the destination selected on the screen at the time of communication, for example, by scrolling a destination on a small display screen. Generally, address book information is registered by inputting alphabetic characters, numeric characters, or kana characters one by one by a user using a ten-key pad of a communication terminal. Therefore, to input address book information of all destinations to be registered at each communication terminal, it takes much labor and time, and a troublesome operation must be performed. Furthermore, the formats of address books prepared at communication terminals are respectively unique and they cannot be shared.

To eliminate the labor of registering address book information of all destinations to be registered, registration of destination address information may be requested for a service person or a service center. However, in this case, a certain amount of expense must be borne. Further, destination address information which can be shared by regions and enterprises is efficiently used if the information having the same contents are centrally controlled and are distributed for copying at each communication terminal. As a method for solving such a problem comparatively easily, a method for processing and controlling the address book formed as a centralized type or a discentralized type data base may be considered.

As such an example, U.S. Pat. No. 3,085,281 proposes that communication terminal equipme sends information of a person himself including installation position information to a central server and receives a URL of a regional server. Then, it connects to the regional server, and receives a service menu from the regional server. Then, it selects and preserves the service menu. Thus customization is realized. However, in this example, a problem arises that the format of data recorded in an address book of the communication terminal is limited to a format of a type provided by the regional server.

Generally, the items constituting an address book are different from the terminal to the terminal. Further, ways of using the address book including the kind of data forming master data and number of items to be used are different among diferent users. Therefore, when data of a data base are shared by all the communication terminals as master data for their address book data, it is necessary to prepare an address book control tool corresponding to all the communication terminals for each data base. However, the operation of preparing such an address control tool is enormous.

A system for solving the aforementioned problem that the format of an address book is limited to a a specific data base and a problem that the system configuration applicable to a different communication terminal becomes large is disclosed in Japanese Patent Application 2003-259031. In the invention disclosed in this patent application, a control server is installed separately from an LDAP server or a data base server, which stores master data, and prepares an address book corresponding to a plurality of formats from the master data, thereby being applicable to a plurality of different address books.

However, it is essential to install a control server separately from the LDAP server in this system. The reason is that when using an address book preset in another communication terminal by a communication terminal to be newly introduced, the communication terminal to be newly introduced has to establish a new address book by obtaining an address book from the master data registered in the control server.

Further, in many cases, the control server has a different specification among different manufacturers, since an address book is prepared in a unique format of the manufacturer, and the protocol of the control server is often a unique one of the manufacturer. In such a case, a system using the aforementioned control server is usually not open and a problem arises that the address book cannot be shared due to a mismatch of the protocol with a communication terminal manufactured by a manufacturer different from the manufacturer of the control server.

Therefore, an open address book information sharing system applicable to a multi-vender communication terminal and a communication terminal having various address book specifications without installing a control server in addition to the LDAP server is desired.

### SUMMARY OF THE INVENTION

An object of the present invention is to provide an address book information sharing system capable of, without installing a particular server, enabling communication terminals having address books under different specifications to mutually share and use information of the address books of the respective communication terminals, a communication terminal used in this system, and to provide a method for sharing an address book information.

According to an embodiment of the present invention, an address book information sharing system includes an LDAP server, having a server software of a lightweight directory access protocol (LDAP) installed and having a storage devie which stores a sharing address book, a first communication terminal, a second communication terminal, and a communication network for connecting them. The first communication terminal includes an address book storage device which stores address information of a plurality of communication destinations, an address book relating table for relating the address information stored in the address book storage device to the address information stored in the sharing address book of the LDAP server, an address book converter which refers to the address book relating table and converting the information stored in the address book storage device of the first communication terminal to information compatible with the sharing address book, and an LDAP client unit having a client LDAP software installed for writing and registering the address book information converted by the address book converter in the sharing address book of the LDAP server via the communication network. The second communication terminal includes an address book storage device for storing address information of a plurality of communication destinations, an LDAP client unit having a client LDAP software installed for accessing the LDAP server via the communication network and obtaining the information of the sharing address book, an address book relating table for relating the information stored in the sharing address book of the LDAP server to the information stored in the address book storage device of the second communication terminal, and an address book converter which refers to the address book relating table, converting the address information of the sharing address book of the LDAP server obtained by the LDAP client unit to information compatible with the address information stored in the address book storage device, and writing the converted sharing address book information into the address book storage device.

Further, according to the embodiment of the present invention, the communication terminal for writing and registering data in the sharing address book of the LDAP server includes an address book storage device which stores address information of a plurality of communication destinations, an address book relating table for relating the address information stored in the address book storage device to the address information stored in the sharing address book of the LDAP server, with a server software of a lightweight directory access protocol (LDAP) installed, having a storage device of a sharing address book, an address book converter which refers to the address book relating table and converting the address information stored in the address book storage device to information compatible with the sharing address book, and an LDAP client unit having an installed client LDAP software for writing and registering the address book information converted by the address book converter in the sharing address book of the LDAP server via the communication network.

Further, according to the embodiment of the present invention, the communication terminal for accessing the LDAP server and for obtaining the address information of the sharing address book includes an address book storage device which stores address book information of a plurality of communication destinations, an LDAP client unit with a client LDAP software and a server software of a lightweight directory access protocol (LDAP) installed via the communication network for accessing the LDAP server having a storage device of the sharing address book and obtaining the information of the sharing address book, an address book relating table for relating the address information stored in the sharing address book of the LDAP server to the address information stored in the address book storage device of the communication terminal, and an address book converter which refers to the address book relating table and for converting the address information of the sharing address book of the LDAP server obtained by the LDAP client unit to information compatible with the address information stored in the address book storage device, and writing the converted sharing address book information into the address book storage device.

According to the embodiment of the present invention, a method for sharing an address book information includes steps of; writing and registering address information of a communication destination stored in the address book storage device of a first communication terminal, having a client LDAP software installed, into a LDAP server, with the LDAP server software installed, having a storage device which stores the address information of the sharing address book through the first communication terminal, accessing the LDAP server by the second communication terminal having the client LDAP software installed to obtain the address information of the sharing address book from the LDAP server by the second communication terminal, and storing the obtained sharing address information in the second communication terminal. The step of writing and registering the address information stored in the address book storage device into the LDAP server by the first communication terminal further includes steps of; relating the address book information stored in the first communication terminal to the information of the sharing address book of the LDAP server, converting the address information of the address book to address information compatible with the sharing address book, and writing and registering the address information converted in the address book conversion step into the sharing address book of the LDAP server. The step of obtaining the address information of the sharing address book from the LDAP server by the second communication terminal to store the information in the second communication terminal further includes steps of; accessing the LDAP server to obtain the address information of the sharing address book, relating the address information stored in the sharing address book of the LDAP server to the address information of the address book of the second communication terminal, converting the address information of the sharing address book obtained from the LDAP server to address information compatible with the address information of the address book of the second communication terminal, and storing the address information of the sharing address book obtained from the LDAP server, which is converted to the address information compatible with the address information of the address book, in the second communication terminal.

Further, according to the embodiment of the present invention, the method for sharing an address book information includes steps of; relating the address information stored in the storage device of the communication terminal having the client LDAP software installed to the information of the sharing address book of the LDAP server, with the server software of the lightweight directory access protocol (LDAP) installed, having the storage device of the sharing address book, converting the address book information stored in the storage device of the communication terminal to information compatible with the sharing address book, and writing and registering the address book information converted in the address book conversion step into the sharing address book of the LDAP server.

Further, according to the embodiment of the present invention, method for sharing an address book information includes steps of; accessing the LDAP server, with the server software of the lightweight directory access protocol (LDAP) installed, having the storage device of the sharing address book by the communication terminal to obtain the address information of the sharing address book, relating the address information stored in the sharing address book of the LDAP server to the address information stored in the address book storage device of the communication terminal, converting the address information of the sharing address book obtained from the LDAP server to information compatible with the address information of the address book of the communication terminal, and storing the address information of the sharing address book obtained from the LDAP server, which is converted to the information compatible with the address information of the address book, in the communication terminal.

### BRIEF DESCRIPTION OF THE DRAWINGS

Further objects, features and advantages of the invention can be more fully understood from the following detailed description taken in conjunction with the accompanying drawings, in which:

FIG. 1 is a block diagram for explaining the system configuration of an embodiment of the present invention,

FIGS. 2A and 2B are block diagrams showing the hardware configuration of the communication terminal of an embodiment of the present invention,

FIGS. 3A and 3B are block diagrams showing the function configuration of the communication terminal of an embodiment of the present invention,

FIG. 4 is a drawing exemplarily showing a setting of the address relating table of an embodiment of the present invention,

FIG. 5 is a drawing for exemplarily explaining an address book conversion of an embodiment of the present invention,

FIGS. 6A, 6B, and 6C are flow charts for explaining the operation of the communication terminal of an embodiment of the present invention,

FIG. 7 is a block diagram showing the function configuration of the communication terminal of an embodiment of the present invention,

FIG. 8 is a drawing exemplarily showing a setting of the address relating table of an embodiment of the present invention,

FIG. 9 is a drawing for exemplarily explaining an address book conversion of an embodiment of the present invention, and

FIG. 10 is a flow chart for explaining the operation of the communication terminal of an embodiment of the present invention.

### DETAILED DESCRIPTION OF THE INVENTION

Hereinafter, an embodiment of the present invention will be explained with reference to the accompanying drawings.

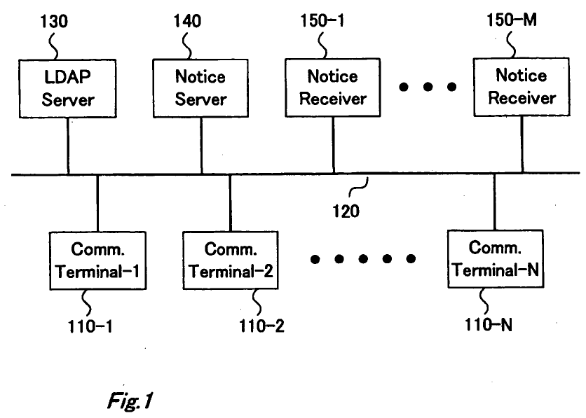

FIG. 1 is a block diagram for explaining the constitution of the address book information sharing system of this embodiment. Needless to say, the system configuration indicated here may be modified properly, if the essential function of the present invention is executed. At a communication terminal 110, a client software of a lightweight directory access protocol (hereinafter, abbreviated to LDAP) specified by the Request for Comments (RFC) of the Internet Engineering Task Force (IETF) is installed and is connected to a communication network 120. The LDAP is an open directory system based on the standard X.500 of the International Telecommunication Union Telecommunication Standardization Sector (ITU-T), which requires no full stack of OSI and is positioned as a sub-set of X.500. The communication terminal 110 also has an address book used at its terminal. As a communication terminal, for example, a facsimile terminal, a telephone set, and the so-called multifunction peripheral (hereinafter, abbreviated to MFP) may be cited.

To the communication network 120, an LDAP server 130 is also connected. On the LDAP server 130, a server LDAP software is installed.

The LDAP server 130 and the communication terminal 110 form an LDAP server/client system. Namely, the LDAP server 130, by the LDAP directory service function, has a storage device which stores a sharing address book according to the standard of the LDAP and has a function for responding to the communication terminal 110 which is an LDAP client. Therefore, the communication terminal having a configulation, which will be described later, enables writing and registering the address book information of the terminal into the LDAP server. Further, the communication terminal accesses to the LDAP server to obtain the information of the sharing address book registered in the LDAP server, and uses the obtained sharing address book information in the address book of the communication terminal.

A sharing address book update notice server 140 and a sharing address book update information notice receiver 150 for receiving sharing address book update information are connected to the communication network 120, when necessary.

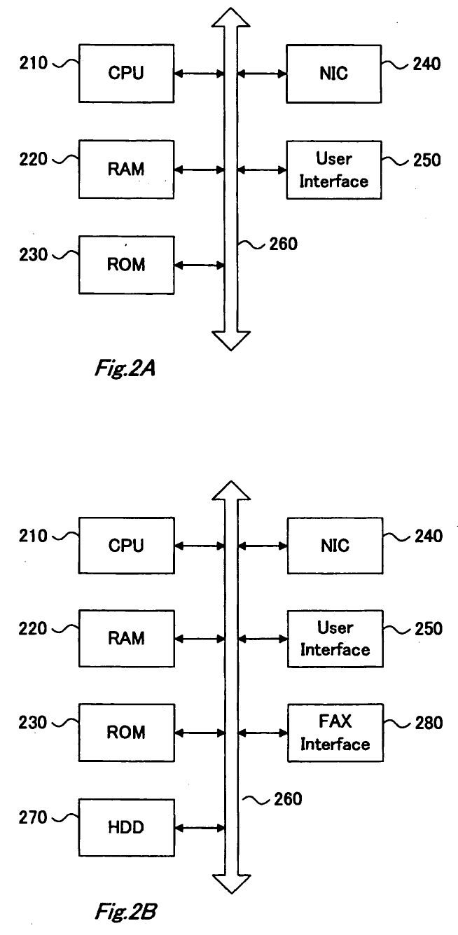

FIG. 2A is a block diagram for explaining the basic hardware configuration of the communication terminal 110 of this embodiment. Further, needless to say, the basic hardware configuration shown in FIG. 2A and the hardware configuration which will be shown in FIG. 2B later, may be modified properly, if the essential function of the present invention is executed. The communication terminal 110 has a CPU 210, a RAM 220, a ROM 230, a network interface circuit (NIC) 240, and a user interface (UI) 250, which are mutually connected by a system bus 260. Th CPU 210 executes various processes at the communication terminal 110. For example, the CPU 210, on the basis of the communication control software stored in the ROM 230, controls communication with other devices connected to the communication network 120.

The RAM 220 functions as a main memory and a work area of the CPU 210.

In the ROM 230, the control software to be executed by the CPU 210 and data are stored. In the control software stored in the ROM 230, the client LDAP software and a software performing an address book conversion, which will be described later are included. Further, in data stored in the ROM 230, data of the address book relating table which will be described later and data of the address book of the communication terminal thereof are included. The number of ROMs mounted in the communication terminal 110 is not always one, and two or more ROMs may be mounted. Further, the ROM 230 may be an EEPROM capable of electrically writing or erasing data or a flash memory. Particularly the ROM capable of electrically writing and erasing data is suited for storing data of the address book relating table, when it is necessary to store data of the address book of the communication terminal and to prepare for a future revision of the standard of the LDAP.

The network interface circuit (NIC) 240 is, for example, an interface circuit for supporting 100Base.T.

The user interface (UI) 250 has an operation input means enabling a user to perform an operation such as data input of an address book or command input to the communication terminal 110, a display capable of visually observing a user's operation and information linked with the communication terminal, and a means for controlling them.

FIG. 2B is a block diagram for explaining the hardware configuration where the communication terminal 110 in this embodiment is the so-called multifunction peripheral (hereinafter, abbreviated to MFP) having two or more of the printing function, such as a copying function, and a facsimile (hereinafter, abbreviated to FAX) communication function. As compared with the basic hardware configuration shown in FIG. 2A, a fixed disk drive (HDD) 270 and a FAX communication interface 280 are added. Further, the MFP has a printer for forming images and a paper conveyer, which are not shown. In the HDD 270, image data necessary for image formation can be stored, as well as the software including a part of or all of the data stored in the ROM 230 in the basic constitution shown in FIG. 2A. The FAX communication interface 280 includes a communication protocol for transmitting or receiving a facsimile signal as well as a MODEM function.

Hereinafter, firstly, the function configuration and operation for writing and registering the address book information of the communication terminal of the embodiment of the present invention into the LDAP server from the communication terminal will be explained. Secondly, the function configuration and operation for obtaining the address book information registered in the LDAP server by another communication terminal according to the embodiment of the present invention and for using it in the address book of the communication terminal will be explained.

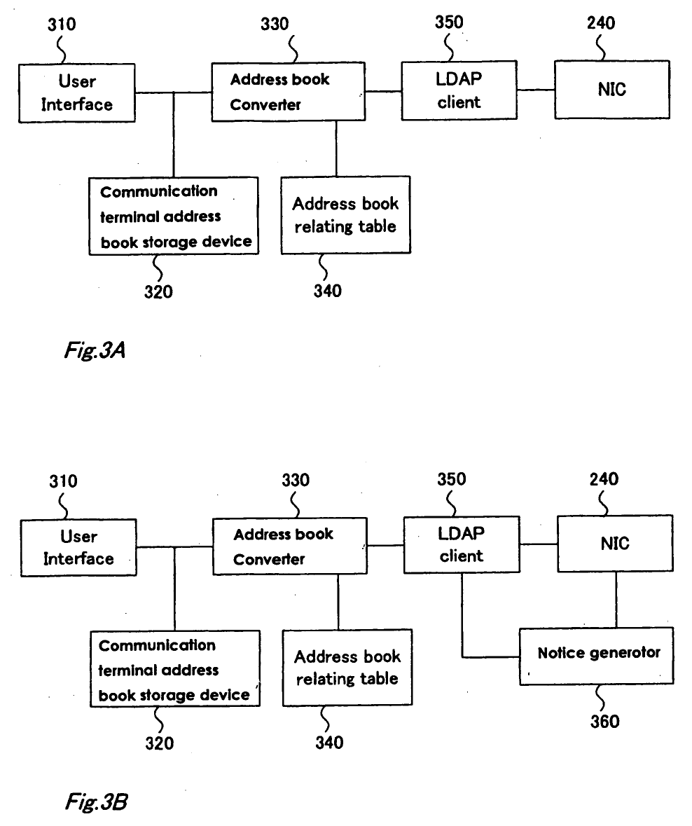

FIGS. 3A and 3B are block diagrams showing the function configuration of the process at the communication terminal 110 when writing and registering the address book information into the LDAP server 130 at the communication terminal 110. Needless to say, the function configuration indicated here may be modified properly, if the essential function of the present invention is executed. Firstly, the basic function configuration will be explained by referring to FIG. 3A.

A user interface 310 can be used by a user to input the name of his communication destination, telephone number, e-mail address, and other necessary address information. Further, the user interface 310 can be used to start the process of an address book converter 330 which will be described later. It may be possible to designate the process object of address book converter at that time. The user interface 310 is formed, for example, by using a touch panel.

Address book storage device 320 stores the address book used by the communication terminal 110. The address book storage device 320 is realized, for example, by an ROM which can electrically write and erase data.

An address book converter 330 processes the address book information with or without correction inputted by the user interface 310 by referring to an address relating table 340.

Here, to clearly explain the address relating table and address book conversion, some terms will be explained.

In the embodiment of the present invention, a set of data for each individual destination stored in the address book of the communication terminal is referred to as a “record”. Further, in the embodiment of the present invention, an item of the address book of the communication terminal is referred to as a “field”. The field is composed of a field item representing the name of item and a field value representing the item contents. One record is generally composed of a plurality of fields.

On the other hand, a set of data for each individual destination stored in the sharing address book of the LDAP server is referred to as an “entry” in the embodiment of the present invention. Further, in the embodiment of the present invention, an item of the sharing address book of the LDAP server is referred to as an “attribute”. The attribute is composed of an “attribute type” representing the name of item and an “attribute value” representing the item contents. One entry is generally composed of a plurality of attributes.

The field items of the address book of the communication terminal and arrangement thereof are various depending on the manufacturer and kind of the communication terminal, while the attribute types of the sharing address book of the LDAP server are specified by the standard of the LDAP and the number of attribute types of the attributes of the same meaning is one.

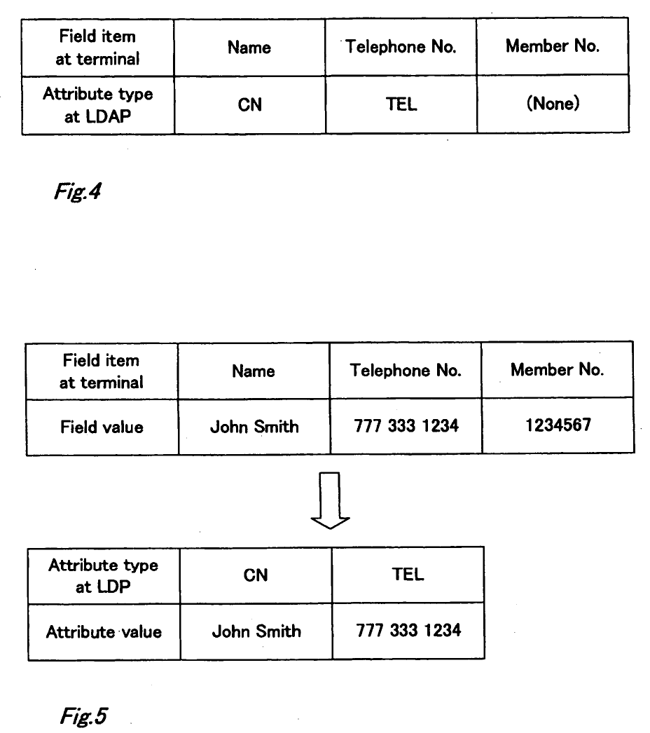

Now, lets assume that the record of a certain communication terminal has three fields consisting of a name, a telephone number and a membership number, and that the respective field values are John Smith, 777 333 1234, and 1234567. The address relating table 340 is a table for relating the field items of the address book of the communication terminal to the attribute types of the sharing address book of the LDAP server. According to the RFC:2256 (A Summary of the X.500 User Schema for use with LDAPv3) of the IETF, there are attribute types of the sharing address book of the LDAP server corresponding to a Country (c), an organization (o), a lower level organization in (ou), a full name (cn), and a telephone number (TEL). However, there is no attribute type of the sharing address book of the LDAP server corresponding to the membership number. FIG. 4 is a drawing for explaining the address relating table of this communication terminal. From the address relating table shown in FIG. 4, it is found that the fields of name and telephone number of the address book of the communication terminal are respectively related to the attribute types of CN and TEL of the sharing address book of the LDAP server. However, the field item of membership number of the address book of the communication terminal does not exist in the attribute type of the sharing address book of the LDAP server, so that it is found that the field item is not related to the attribute type. The field items of the address book of the communication terminal vary with the manufacturer and kind of the communication terminal, so that the address book relating table also varies with the manufacturer and kind of the communication terminal.

The address converter 330, firstly, can decide whether among the field items of a record of the communication terminal, there is an item corresponding to an attribute type of the sharing address book of the LDAP server. At this stage, when it is decided that among the field items of the record of the communication terminal, there is not an item corresponding to an attribute type of an entry of the sharing address book of the LDAP server at all, the address converter 330 does not perform the subsequent process.

The address book converter 330, when it decides that among the field items of the record of the communication terminal, there is an item corresponding to an attribute type of the entry of the sharing address book of the LDAP server, generates an entry corresponding to the record of the address book of the communication terminal 110. Here, the attribute type of the generated entry is assumed as an attribute type related to the field item of the address book of the communication terminal 110 by the address relating table 340 and the attribute value of the entry is the same as the field value of the record. However, when among the field items of the address book of the communication terminal 110, there is no item corresponding to an attribute type of the sharing address book of the LDAP server of the address relating table 340, the field is ignored and the entry is not reflected.

FIG. 5 is a drawing for explaining about the address book conversion by referring to the aforementioned record as an same example. In FIG. 5, the upper table shows the record of the address book of the communication terminal 110 and the lower table shows the entry generated based on the record. As shown in FIG. 5, the field item “Name” is converted to the attribute type “CN” of the sharing address book of the LDAP server and the attribute value of CN is John Smith. Further, the field item “Telephone No.” is converted to the attribute type “TEL” of the sharing address book of the LDAP server and the attribute value of TEL is 777 333 1234. The field of membership No. is not reflected on the entry.

Address book information of the communication terminal converted to a format compatible with the sharing address book of the LDAP server by the address book converter 330 is transferred to an LDAP client 350. The LDAP client 350, via the NIC 240 and the communication network 120, writes the information into the sharing address book of the LDAP server 130. Here, the address book information for each communication terminal can be registered in the sharing address book of the LDAP server 130 and the address book information of a plurality of communication terminals can be registered together in the sharing address book of the LDAP server 130.

Further, in the above explanation, one record of the address book of the communication terminal is written into the sharing address book of the LDAP server 130. However, it is possible to execute address book conversion for a plurality of records of the communication terminal by writing them together into the sharing address book of the LDAP server 130.

By use of the functional configuration explained above, the address book information of the communication terminal can be written and registered in the sharing address book of the LDAP server, as long as the field items of the address book of the communication terminal are related to the attribute types of the sharing address book of the LDAP server. Furthermore, writing and registering data in the sharing address book of the LDAP server can be automatically executed when the address book conversion process of the communication terminal is started.

A block diagram of the functional configuration is shown in FIG. 3B, wherein the communication terminal, in addition to the basic function, has a function for generating a notice toward the communication network 120 when it writes and registers the address book information in the LDAP server. The difference from the basic function configuration shown n FIG. 3A is that a notice generator 360 is added. The notice generator 360, upon receipt of, for example, from the LDAP client 350, a signal indicating that the address book information of the communication terminal thereof is written and registered in the sharing address book of the LDAP server, sends sharing address update information toward the communication network via the NIC 210. However, needless to say, the starting conditions of sending of the sharing address book update information may be modified properly, if the essential function of the present invention is executed. The sharing address book update information includes information discriminating the communication terminal whose address book is updated and information concerning the address book update date and update contents can be added to it, when necessary. The notice generator 360 may be, for example, an e-mail transmiter. In this case, the sharing address book update information is received and stored by the sharing address book update notice server 140 shown in FIG. 1. Thus a user can know the contents of the update information using the mail software installed in the sharing address book update information receiver 150.

Namely, in this case, the sharing address book update notice server 140 corresponds to a mail server and the sharing address book update information receiver 150 to a computer in which the mail software is installed.

Since the sharing address book update notice function is added, the address book of communication terminals other than the communication terminal sending the sharing address book update information notice can be updated timely, using a function for asking the LDAP server from the communication terminal, which will be explained later. As an example of the notice generator 360, the e-mail transmitter is cited above. However, needless to say, if the aforementioned object and function are executed, other means such as Web may be used. Further, by adding the notice generator 360, the function and advantages realized by the basic function configuration shown in FIG. 3A will not be impaired.

Next, the operation of the communication terminal 110 according to the embodiment of the present invention will be explained, for writing and registering the address book information thereof into the sharing address book of the LDAP server 130.

There are two different types of writing and registering the address book information in the sharing address book of the LDAP server 130 from the communication terminal 110. In one type, the writing and registering of the address book information, which is already stored in the communication terminal 110 is tried, wherei all of or a part of the records of the address book of the communication terminal 110 are registered into the sharing address book of the LDAP server 130 are. This type of writing and registering is called general writing register in the embodiment of the present invention. The general writing register is effective, for example, in construction of a system according to the present invention by newly introducing an LDAP server, when the communication terminal 110 according to the embodiment of the present invention has an address book of fully recorded. In the other type the writing and registering of the address book information of the communication terminal 110 including changed records is tried into the sharing address book of the LDAP server 130. This type is called update writing register in the embodiment of the present invention. The update writing register is effective, for example, when adding a new record to the address book of the communication terminal 110 according to the embodiment of the present invention, or when correcting or updating data of a record already existing in the address book to newest data.

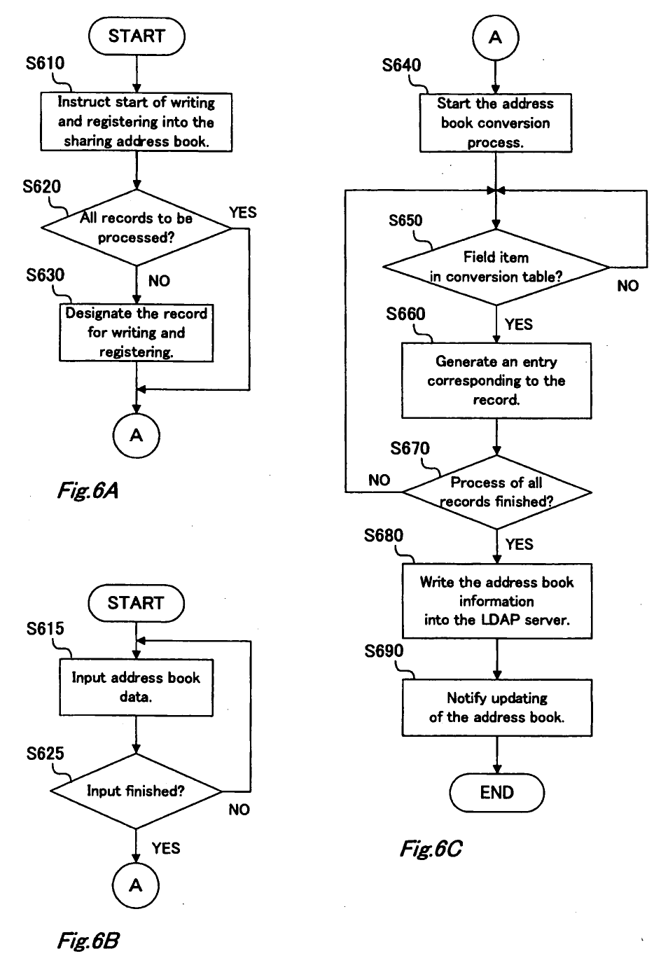

FIGS. 6A and 6C are flow charts for explaining the operation of the communication terminal 110 when executing general writing for registration of the address book information thereof in the sharing address book of the LDAP server 130, from the communication terminal 110 according to the embodiment of the present invention.

FIG. 6A is a flow chart for explaining the operation for identifying an object to be written for registration in the sharing address book before performing the address book conversion process. Further, FIG. 6C is a flow chart for explaining the operation for writing and registering of the address book information of the communication terminal into the sharing address book of the LDAP server, which is subject to the address book conversion process.

A user of the communication terminal 110 generates a command for starting the process of writing and registering the address book information of the communication terminal thereof into the sharing address book of the LDAP server 130, using the user interface 310, at Step S610. Then, a message is displayed on the user interface, at Step S620, asking the user whether or not to he or she writes and registers all the records of the address book of the communication terminal thereof in the sharing address book.

When the user selects the process of writing and registering all the records into the sharing address book, the process goes to A shown in FIG. 6A, skipping S630, and then goes to the steps shown in FIG. 6C.

When the user selects to perform the process of writing and registering not all the records into the sharing address book, at Step S630, the user designates a record which is an object of the process of writing and registering into the sharing address book or designates a record which is not an object of the process of writing and registering into the sharing address book, thereby identifying an object of the process of writing and registering into the sharing address book.

FIG. 6C is a flow chart for explaining the operation of writing and registering the address book information, which is an object of the process of writing and registering into the sharing address book, into the sharing address book of the LDAP server 130. For the record identified in FIG. 6A which is an object of the process of writing and registering in the sharing address book, the process starts at S640. Next, the address book converter 330 refers to the address book relating table 340 and judges whether there is a field item corresponding to the attribute type of the sharing address book of the LDAP server 130 among the field items of the record which is an object of the writing and registering process, at S630. At this stage, when it is judged that there is no field item corresponding to the attribute type of the sharing address book of the LDAP server 130 among the field items of the record which is an object of the writing and registering process, the subsequent process is not performed for the record and the process is finished.

The address book converter 330 generates an entry corresponding to the record, at S660, when it judges that among the field items of the record which is an object of the writing and registering process, there is a field item corresponding to the attribute type of the sharing address book of the LDAP server 130. The attribute type of the entry is assumed as an attribute type related to the field item by the address book relating table 340 and the attribute value of the entry is the same as the field value of the record. When the same process is performed for all the fields of the record, the record is converted to the entry. However, a field item of the record is ignored and the field item is not reflected on an entry generated, if it is not corresponding to the attribute type of the sharing address book of the LDAP server 130.

When one entry is generated for one record, the similar processes are performed for other records which are objects of the writing and registering process to generate corresponding entries until all the records are processed (S670). When the address book converter 330 completes the process for all the records which are objects of the writing and registering process, it finishes the address book conversion process.

The address book information of the communication terminal thus converted to the entry compatible with the sharing address book of the LDAP server 130 is transferred to the LDAP client 350 from the address book converter 330.

The LDAP client 350 to which the address book information is transferred, writes and registers the address book information of the communication terminal into the sharing address book of the LDAP server 130 via the NIC 240 and the communication network 120, at S680. Here, it is possible to install the sharing address book in each communication terminal connected to the communication network 120 or to install one sharing address book in the communication network. With the above process at the communication terminal 110, the address book information of the communication terminal is reflected on the sharing address book of the LDAP server 130.

In the communication terminal 110 having the basic function shown in FIG. 3A, the process of writing and registering the address book information into the LDAP server 130 is finished at S680.

In the communication terminal 110 having the function shown in FIG. 3B, the LDAP client 360 transfers a signal indicating the writing and registering the address book information of the communication terminal into the address book of the LDAP server 130 to the notice generator 360. The notice generator 360 sends the sharing address book update information toward the communication network 120 via the NIC 210 and completes a series of processes, at S690.

Next, the operation of the communication terminal 110 according to the embodiment of the present invention will be explained, when update-writing and registering the address book information thereof into the sharing address book of the LDAP server 130.

The user inputs the address book data of the communication terminal 110 using the user interface 310, at S615. Namely, the field values of the record of the address book are inputted, irrespective of whether the data to be inputted is new one or corrected one of the existing data. Whether the inputting of the address book data of the communication terminal is completed or not is judged at S625 following S615, and the process is returned to “Address book data input” when it is not finished, at S615.

When the inputting of the address book data of the communication terminal is completed, an object of the writing and registering process is identified and the process goes via A shown in FIG. 6B to the steps shown in FIG. 6C. The process shown in FIG. 6C is the same as that of the general writing and registering explained already, so that detailed explanation will be omitted. However, for the record which is an object of the writing and registering process, the address book conversion process is performed and then it is written and registered into the sharing address book of the LDAP server 130. When the communication terminal 110 has the function shown in FIG. 6B, the sharing address book update information is further sent toward the communication network 120.

In the update writing and registering explained above, the process shown in FIG. 6C can be performed automatically when the inputting of the address book data is finished at the communication terminal. Namely, the input address book information can be automatically written and registered into the sharing address book of the LDAP server, when the inputting of the address book data at the communication terminal is completed.

The function and operation have been explained for writing and registering the address book information in the communication terminal according to the embodiment of the present invention into the sharing address book of the LDAP server.

Next, the function and operation for using the information in the sharing address book registered in the LDAP server for the address book of the communication terminal according to the embodiment of the present invention will be explained.

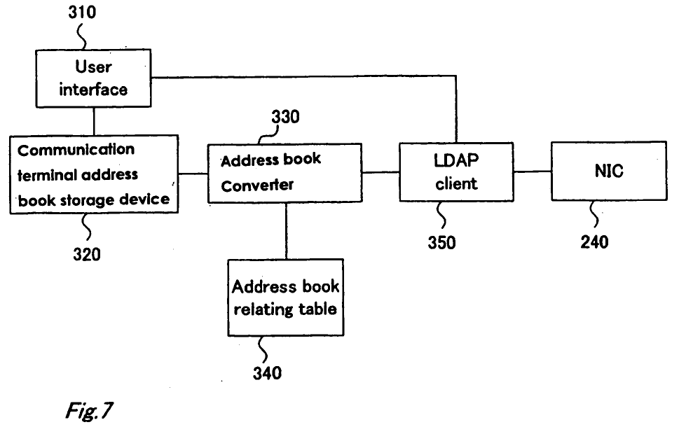

FIG. 7 is a block diagram showing the process in the communication terminal, in which the sharing address book information registered in the LDAP server is obtained by the communication terminal 110 and the information is used in the address book of the communication terminal. Needless to say, the function indicated here may be modified properly, if the essential function of the present invention is executed.

The user interface 310 has a function, according to a user's operation, for accessing the LDAP server 130 by the communication terminal 110 and transferring a command for obtaining the information of the sharing address book registered in the LDAP server 130 to the LDAP client 350. Here, the information of the sharing address book which is registered in the LDAP server 130 and can be obtained by the communication terminal 110 includes the information capable of identifying the sharing address book registered in the LDAP server 130 and the data of the entry of the sharing address book. The user can select one desired sharing address book, when a plurality of sharing address books are registered in the LDAP serer 130, using the user interface 310. Furthermore, the user can select one or more entries from the selected sharing address book using the user interface 310. Further, the user interface 310 has a function for inputting, by a user's operation, the name, telephone number, and e-mail address of the communication destination and other necessary field values.

The LDAP client 350 transfers the command, inputted to the user interface 310, to the LDAP server 130 for inquiring according to the LDAP protocol via the NIC 240 and the network 120. The response from the LDAP server 130 to the inquiry is transferred to the LDAP client 350 made the inquiry via the network 120 and the NIC 240.

The LDAP client 350 to which the response from the LDAP server 130 is transferred transfers the response information from the LDAP server 130 to the user interface 310 when the response requires any selection operation by the user and to the address book converter 330 after the user's selection operation is finished.

When the response transferred to the LDAP client 350 from the LDAP server 130 is a name list of the sharing address books of the LDAP server, the information of the name list is transferred to the user interface 310. At this time, the user can select a necessary sharing address book using the user interface 310. Further, when the response transferred to the LDAP client 350 from the LDAP server 130 is an entry registered in the sharing address book of the LDAP server selected by the user, the entry information is transferred to the user interface 310. At this time, the user can select a necessary entry or an unnecessary entry using the user interface 310.

When the selection by the user is completed, the selected entry is transferred from the LDAP server 130 to the address book converter 330 via the LDAP client 350. The address book converter 330 refers to the address relating table 340 to check whether the attribute type of the transferred entry is in it. The address relating table 340 is a table for relating the field items of the address book of the communication terminal to the attribute types of the sharing address book of the LDAP server. When the attribute type of the entry transferred to the address book converter 330 is not in the address relating table 340 at all, the address book converter 330 does not perform the address book conversion process for the entry.

When the attribute type of the entry transferred to the address book converter 330 is in the address relating table 340, the address book converter 330 generates a record corresponding to the entry. The field item of the generated record is assumed as a field item to be related to the attribute type of the entry according to the address relating table 340 and the field value of the generated record is assumed as the same as the attribute value of the entry. Here, the attribute type of the entry having no field item related according to the address relating table 430 is ignored.

For better understanding of the functions of the address book converter 330 and the address relating table 340, an example will be explained. A case will be explained, in which the LDAP client receives from the LDAP server 130 an entry having three attribute types of name (CN), telephone No. (TEL), and organization (O) and attribute values of Mary Williams, 222 555 9876, and ABCDEFG Corp. and the information is transferred to the address book converter 330.

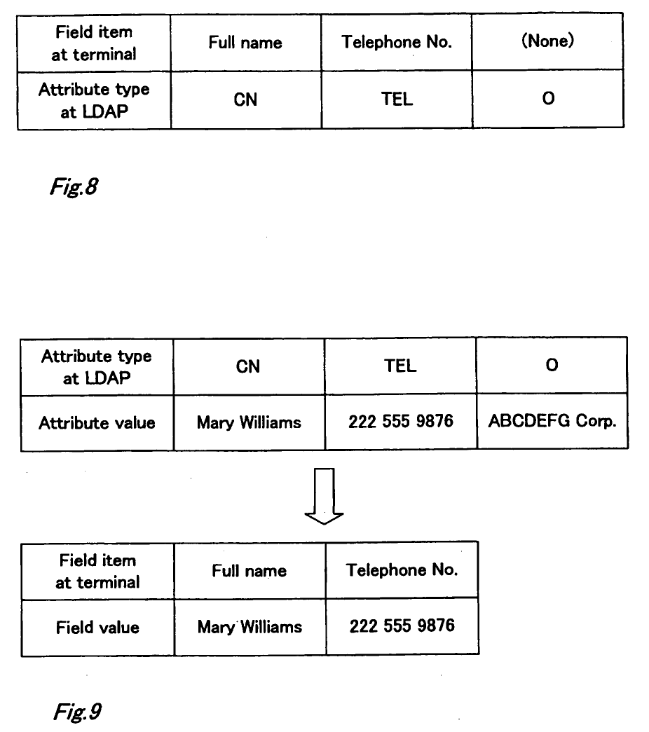

FIG. 8 is a drawing for explaining the address relating table 340 of the communication terminal. From the address relating table shown in FIG. 8, it is found that the fields of full name and telephone No. of the address book of the communication terminal are respectively related to the attribute types of CN and TEL of the sharing address book of the LDAP server. However, the address book of the communication terminal has no item corresponding to organization (O), so that it is found that the attribute type O of the sharing address book of the LDAP server is not related to. Further, the field items of the address book of the communication terminal vary with the manufacturer and kind of the communication terminal, so that the address book relating table also varies with the manufacturer and kind of the communication terminal.

FIG. 9 is a drawing for explaining address conversion using the entry received from the LDAP server. In FIG. 9, the upper half indicates the entry received from the LDAP server and the lower half indicates the record of the address book of the communication terminal 110 which is a result that the entry is address-converted. As clearly shown in FIG. 9, the attribute type “CN” of the sharing address book of the LDAP server is converted to the field item “Full name” and the field value is set to Mary Williams. Further, the attribute type “TEL” of the sharing address book of the LDAP server is converted to the field item “Telephone No.” and the field value is set to 222 555 9876. When the field item to be related to is not in the address book of the communication terminal, the attribute type “O” (attribute value: ABCDEFG Corp.) of the entry is not reflected on the record of the address book of the communication terminal 110.

The address book information converted to the format compatible with the address book of the communication terminal 110 by the address book converter 330 is transferred to the communication terminal address book storage device 320 and the communication terminal address book storage device 320 stores the address book information.

In the above explanation, one entry of the sharing address book of the LDAP server 130 is converted to one record of the communication terminal and is written into the address book of the communication terminal. However, it is clear that a plurality of records of the sharing address book of the LDAP server 130 are written together into the address book of the communication terminal, thereby using them in the communication terminal.

By use of the function explained above by referring to FIGS. 7 to 9, the sharing address book information of the LDAP server can be used in the address book of the communication terminal as long as the attribute types of the entry registered in the sharing address book of the LDAP server are related to the filed items of the address book of the communication terminal.

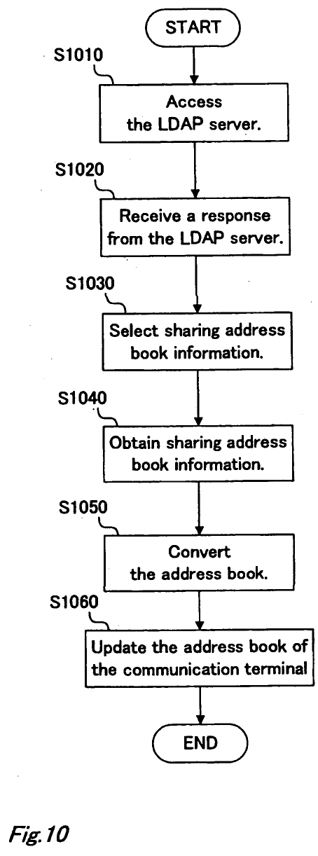

FIG. 10 is a flow chart for explaining the operation of the communication terminal 110 when obtaining and using the sharing address book information of the LDAP server 130 at the communication terminal 110. Needless to say, the operation indicated herecan be modified properly, if the essential function of the present invention is executed.

At S1010, the LDAP client 350 of the communication terminal 110 generates a command for accessing the LDAP server 130 and obtaining the sharing address book information registered in the LDAP server 130 by operating the user interface 310 by the user. Althogh the user may take the above action at any time, he can know that the sharing address book of the LDAP server is updated earlier and can take the action timely, when the communication terminal 110 having the notice generator 360 shown in FIG. 3B sends the sharing address book update information. The LDAP client 350 accesses the LDAP server 130 via the NIC 240 and the communication network 120 and inquires the sharing address book information of the LDAP server 130. The LDAP server 130 responds to the inquiry and the LDAP client 350 having made the inquiry receives the response from the LDAP sever 130 at S1020 via the communication network 120 and the NIC 240. The LDAP client 350 received the response transfers the sharing address book information of the LDAP server 130 included in the response to the user interface 310. The sharing address book information in the response from the LDAP server 130 includes the information capable of identifying the sharing address book of the LDAP server 130 and the entry information in the sharing address book thereof.

At S1030, the user looks at the information transferred to and displayed on the user interface 310, operates the user interface 310, thereby selects necessary sharing address book information. A signal capable of discriminating the sharing address book information selected by the user is transferred to the LDAP client 350, which then transfers the signal to the LDAP server 130.

At S1040, the LDAP server 130 receives the signal and transfers the sharing address book information of the LDAP server 130 requested from the LDAP client 350 by the response to the LDAP client 350. Thus, the LDAP client 350 of the communication terminal 110 obtains the sharing address book information of the LDAP server 130. The sharing address book information of the LDAP server 130 obtained is transferred to the address book converter 330 from the LDAP client 350.

The address book converter 330, to which the sharing address book information of the LDAP server 130 is transferred, firstly refers to the address book relating table 340, at S1050. Referring to the address book relating table 340, the address book converter 330 does not perform the address book conversion process for the entry, when the attribute types of the entry of the address book information are not in the address relating table 340 at all. When the attribute type of the entry transferred to the address book converter 330 is in the address relating table 340, the address book converter 330 generates a record corresponding to the entry. The field item of the generated record is assumed as a field item to be related to the attribute type of the entry according to the address relating table 340 and the field value of the generated record is assumed as the same value as the attribute value of the entry. Here, the attribute type of the entry having no field item related according to the address relating table 430 is ignored and is not reflected on the generated record. For all the records of the sharing address book information obtained, the above address book conversion process is performed.

When the address book conversion process is completed, the sharing address book information of the LDAP server 130 converted to the record, which is compatible with the address book of the communication terminal, is transferred to the communication terminal address book 320 and is stored in the communication terminal address book 320 at S1060. The updating of the communication terminal address book is thus completed.

Here, with respect to an item which exists in a field of a record of the communication terminal address book but does not exist in an attribute of an entry of the sharing address book of the LDAP server 130, the user can input the data by operating the user interface 310, when necessary.

When the explanation referring to FIGS. 3 to 10 is summarized, the communication terminals, regarding the record having a field item corresponding to an attribute type of the sharing address book of the LDAP server, can mutually share the address book via the sharing address book of the LDAP server even if the format of the address book varies with the communication terminal. Furthermore, when the LDAP server is connected to another LDAP server and can mutually transmit and receive information, the communication terminals can share also the information of the sharing address books of another LDAP server.

According to the embodiment according to the present invention the communication terminals can share the address book information, without installing a particular control server other than the LDAP server. Therefore, the user does not need to obtain all address book information in order to prepare an address book and is released from the complicated operation, when inputting data to the address book of a communication terminal to be installed newly. The reason is that when address book information of a communication terminal whose address book is already fixed is registered in the sharing address book of the LDAP server, the communication terminal to be introduced newly may obtain the address book information and store in the address book storage device 320 of the communication terminal. Further, when address book information of a certain communication terminal is updated, another communication terminal can update its own address book using the updated address book information. The reason is that when the updated address book information is registered in the sharing address book of the LDAP server from the communication terminal whose address book information is updated, another communication terminal may obtain the updated address book information from the sharing address book of the LDAP server and update the address book of the communication terminal. Furthermore, when the address book information of the communication terminal having a function for notifying the sharing address book update information is updated, another user can know earlier by the sharing address book update information sent by the communication terminal that the address book information of the communication terminal is updated, so that the address book of the communication terminal of another user can be updated timely.

What is claimed is:

1. An address book information sharing system comprising an LDAP server, with a server software of a lightweight directory access protocol (LDAP) installed, having a storage device which stores a sharing address book, a first communication terminal, a second communication terminal, and a communication network for connecting them, wherein:
the first communication terminal includes an address book storage device which stores address information of a plurality of communication destinations,
an address book relating table for relating the address information stored in the address book storage device to address information stored in the sharing address book of the LDAP server,
address book converter which refers to the address book relating table and converting the information stored in the address book storage device of the first communication terminal to information compatible with the sharing address book, and
an LDAP client unit having a client LDAP software installed for writing and registering the address book information converted by the address book converter device into the sharing address book of the LDAP server via the communication network, wherein
the second communication terminal includes address book storage device which stores address information of a plurality of communication destinations,
an LDAP client unit having a client LDAP software installed for accessing the LDAP server via the communication network and obtaining the information of the sharing address book,
an address book relating table for relating the information stored in the sharing address book of the LDAP server to the information stored in the address book storage device of the second communication terminal, and
address book converter which converts the address information of the sharing address book of the LDAP server obtained by the LDAP client unit to information compatible with the address information stored in the address book storage device by referring to the address book relating table, and for writing the converted sharing address book information into the address book storage device.

2. A system according to claim 1, wherein:
the first communication terminal further includes notice generator which provides the communication network with a sharing address book update notice, when the LDAP client unit writes and registers the sharing address book information into the sharing address book of the LDAP server, and
a notice receptor which receives the sharing address book update notice is further connected to the communication network.

3. A communication terminal comprising;
An address book storage device which stores address information of a plurality of communication destinations,
an address book relating table for relating the address information stored in the address book storage device to address information stored in a sharing address book of an LDAP server, having a server software of a lightweight directory access protocol (LDAP) installed, and having storage device of a sharing address book,
address book converter which converts the address information stored in the address book storage device to information compatible with the sharing address book by referring to the address book relating table, and
an LDAP client unit having a client LDAP software installed for writing and registering the address book information converted by the address book converter in the sharing address book of the LDAP server via the communication network.

4. A terminal according to claim 3, wherein:
the communication terminal further includes notice generator which provides the communication network with an address book update notice, when the LDAP client unit writes and registers the sharing address book information into the sharing address book of the LDAP server.

5. A communication terminal comprising:
An address book storage device which stores address book information of a plurality of communication destinations,
an LDAP client unit with a client LDAP software installed and with a server software of a lightweight directory access protocol (LDAP) installed via a communication network for accessing the LDAP server having storage device of a sharing address book and obtaining the information of the sharing address book,
an address book relating table for relating the address information stored in the sharing address book of the LDAP server to the address information stored in the address book storage device of the communication terminal, and
address book converter which refers to the address book relating table, converting the address information of the sharing address book of the LDAP server obtained by the LDAP client unit to information compatible with the address information stored in the address book storage device, and writing the converted sharing address book information into the address book storage device.

6. A terminal according to claim 5, wherein:
the communication terminal further comprises a selector which selects the sharing address book of the LDAP server and/or a selector which selects an entry included in the sharing address book.

7. A communication terminal according to claim 3, wherein:
the address book relating table describes a relation between field items of the address book of the communication terminal and attribute types of the sharing address book of the LDAP server.

8. A communication terminal according to claim 4, wherein:
the address book relating table describes relation between field items of the address book of the communication terminal and attribute types of the sharing address book of the LDAP server.

9. A communication terminal according to claim 3, wherein:
the address book relating table is stored in a ROM capable of electrically writing and erasing.

10. A communication terminal according to claim 4, wherein:
the address book relating table is stored in a ROM capable of electrically writing and erasing.

11. A communication terminal according to claim 3, wherein:
the address book converter judges whether field items of a record of the address book of the communication terminal are related to attribute types of the sharing address book of the LDAP server by referring to the address book relating table and generates an entry corresponding to the record, sets attribute types of the generated entry having attribute types related to the field items by the address book relating table and attribute values of the same values as field values of the record, when judging that they are related,
wherein the address book converter ignores the field items and performs no conversion process, when there are no attribute types corresponding to a part of the field items of the record, and
wherein the address book converter ignores whole the record and performs no conversion process, when judging that no field items are related to attribute types of the sharing address book of the LDAP server.

12. A communication terminal according to claim 4, wherein:
the address book converter judges whether field items of a record of the address book of the communication terminal are related to attribute types of the sharing address book of the LDAP server by referring to the address book relating table and generates an entry corresponding to the record, sets attribute types of the generated entry having attribute types related to the field items by the address book relating table and attribute values of the same values as field values of the record, when judging that they are related,
wherein the address book converter ignores the field items and performs no conversion process, when there are no attribute types corresponding to a part of the field items of the record, and
wherein the address book converter ignores whole the record and performs no conversion process, when judging that no field items are related to attribute types of the sharing address book of the LDAP server.

13. A terminal according to claim 3, wherein:
the address book information is all converted by the address book converter and the converted address book information is written and registered into the sharing address book of the LDAP server.

14. A terminal according to claim 4, wherein:
the address book information is all converted by the address book converter and the converted address book information is written and registered into the sharing address book of the LDAP server.

15. A terminal according to claim 3, wherein:
only address book information updated is converted by the address book converter independently of the sharing address book information of the LDAP server and the converted address book information is written and registered into the sharing address book of the LDAP server.

16. A terminal according to claim 4, wherein:
only address book information updated is converted by the address book converter independently of the sharing address book information of the LDAP server and the converted address book information is written and registered into the sharing address book of the LDAP server.

17. A terminal according to claim 15, wherein:
the conversion process by the address book converter and writing and registering the converted address book information into the sharing address book of the LDAP server are automatically executed with the updating of the address book information executed independently of the sharing address book information of the LDAP server as a turning point.

18. A terminal according to claim 16, wherein:
the conversion process by the address book converter and writing and registering the converted address book information into the sharing address book of the LDAP server are automatically executed with the updating of the address book information executed independently of the sharing address book information of the LDAP server as a turning point.

19. A terminal according to claim 5, wherein:
the address book relating table specifies relation between attribute types of the sharing address book of the LDAP server and field items of the address book of the communication terminal.

20. A terminal according to claim 6, wherein:
the address book relating table specifies relation between attribute types of the sharing address book of the LDAP server and field items of the address book of the communication terminal.

21. A terminal according to claim 5, wherein:
the address book relating table is stored in a ROM capable of electrically writing and erasing.

22. A terminal according to claim 6, wherein:
the address book relating table is stored in a ROM capable of electrically writing and erasing.

23. A terminal according to claim 5, wherein:
the address book converter judges whether field items of a record of the address book of the communication terminal are related to attribute types of the sharing address book of the LDAP server by referring to the address book relating table and generates an entry corresponding to the record, sets attribute types of the generated entry having attribute types related to the field items by the address book relating table and attribute values of the same values as field values of the record, when judging that they are related,
wherein the address book converter ignores the field items and performs a process not reflecting on the generated record, when there are no attribute types corresponding to a part of the field items of the record, and
wherein the address book converter ignores whole the record and performs no conversion process, when judging that no field items are related to attribute types of the sharing address book of the LDAP server.

24. A terminal according to claim 6, wherein:
the address book converter judges whether field items of a record of the address book of the communication terminal are related to attribute types of the sharing address book of the LDAP server by referring to the address book relating table and generates an entry corresponding to the record, sets attribute types of the generated entry having attribute types related to the field items by the address book relating table and attribute values of the same values as field values of the record, when judging that they are related,
wherein the address book converter ignores the field items and performs a process not reflecting on the generated record, when there are no attribute types corresponding to a part of the field items of the record, and
wherein the address book converter ignores whole the record and performs no conversion process, when judging that no field items are related to attribute types of the sharing address book of the LDAP server.

25. A method for sharing address book information comprising steps of:
writing and registering address information of a communication destination stored in address book storage device of a first communication terminal having a client LDAP software installed into an LDAP server, having an LDAP server software installed and a storage device which stores the address information of a sharing address book;
accessing the LDAP server by a second communication terminal having a client LDAP software installed; and
obtaining the address information of the sharing address book from the LDAP server by the second communication terminal and storing the obtained sharing address information in the second communication terminal, wherein the step of writing and registering the address information further comprises steps of;
relating the address book information stored in the first communication terminal to the information of the sharing address book of the LDAP server,
converting the address information of the address book to address information compatible with the sharing address book, and
writing and registering the address information converted into the sharing address book of the LDAP server, and wherein, the step of obtaining the address information further comprises steps of;
accessing the LDAP server and obtaining the address information of the sharing address book,
relating the address information stored in the sharing address book of the LDAP server to the address information of the address book of the second communication terminal,
converting the address information of the sharing address book obtained from the LDAP server to address information compatible with the address information of the address book of the second communication terminal, and
storing the address information of the sharing address book obtained from the LDAP server, which is converted to the address information compatible with the address information of the address book in the second communication terminal.

26. A method for sharing address book information according to claim 25, wherein:
the step of writing and registering the address book information into the LDAP server by the first communication terminal, further comprising;
sending an address book update notice to a communication network to which the communication terminal is connected, when writing and registering the address book information thus converted into the sharing address book of the LDAP server.

27. A method for sharing address book information comprising steps of:
relating address information stored in a storage device of a communication terminal having a client LDAP software installed to information of a sharing address book of an LDAP server, having a server software of a lightweight directory access protocol (LDAP) installed, and having a storage device of a sharing address book;
converting the address book information stored in the storage device of the communication terminal to information compatible with the sharing address book; and
writing and registering the address book information thus converted into the sharing address book of the LDAP server.

28. A method for sharing address book information according to claim 27, further comprising a step of sending an address book update notice toward a communication network to which the communication terminal is connected when writing and registering the address book information thus converted into the sharing address book of the LDAP server.

29. A method for sharing address book information comprising steps of:
accessing an LDAP server having a server software of a lightweight directory access protocol (LDAP) installed, and having a storage device of a sharing address book by a communication terminal and obtaining address information of the sharing address book;
relating the address information stored in the sharing address book of the LDAP server to the address information stored in the address book storage device of the communication terminal;
converting the address information of the sharing address book obtained from the LDAP server to information compatible with the address information of the address book of the communication terminal; and
storing the address information of the sharing address book obtained from the LDAP server, which is converted to the information compatible with the address information of the address book in the communication terminal.

30. A method for sharing address book information according to claim 29, wherein the communication terminal further comprises a step of selecting the sharing address book of the LDAP server and/or selecting an entry included in the sharing address book, when accessing the LDAP server and obtaining the address information of the sharing address book.
